(19) United States
(12) Patent Application Publication
(10) Pub. No.: US 2019/0123378 A1
(43) Pub. Date: Apr. 25, 2019

(54) NONAQUEOUS ELECTROLYTE SECONDARY BATTERY POROUS LAYER

(71) Applicant: Sumitomo Chemical Company, Limited, Tokyo (JP)

(72) Inventors: Takuji YAMAMOTO, Niihama-shi (JP); Kosuke KURAKANE, Osaka (JP); Shizuka IWATA, Osaka (JP)

(21) Appl. No.: 16/168,884

(22) Filed: Oct. 24, 2018

(30) Foreign Application Priority Data
Oct. 24, 2017 (JP) 2017-205592

(51) Int. Cl. H01M 10/058; H01M 2/16; H01M 4/62

(52) U.S. Cl. CPC H01M 10/058; H01M 4/624; H01M 2/16

(57) ABSTRACT

The present invention provides, as a nonaqueous electrolyte secondary battery porous layer which is suitable for production of a nonaqueous electrolyte secondary battery having excellent high-temperature constant-voltage charge preservability, a nonaqueous electrolyte secondary battery porous layer containing an organic filler in an amount of 87% by weight to 99.5% by weight, the organic filler being configured so that an inclination of a straight line on a TG chart, which connects a point at 150° C. and a point at a TG inflection point temperature, is not less than −0.10% by mass/° C.

This Nonprovisional application claims priority under 35 U.S.C. § 119 on Patent Application No. 2017-205592 filed in Japan on Oct. 24, 2017, the entire contents of which are hereby incorporated by reference.

### TECHNICAL FIELD

The present invention relates to a porous layer for a nonaqueous electrolyte secondary battery (hereinafter referred to as “nonaqueous electrolyte secondary battery porous layer”).

### BACKGROUND ART

Nonaqueous electrolyte secondary batteries, particularly lithium ion secondary batteries, have a high energy density and are therefore in wide use as batteries for personal computers, mobile phones, portable information terminals, and the like. Such nonaqueous electrolyte secondary batteries have recently been developed as on-vehicle batteries.

As a member of such a nonaqueous electrolyte secondary battery, a separator having excellent heat resistance has been developed.

As a nonaqueous electrolyte secondary battery porous layer included in a separator for a nonaqueous electrolyte secondary battery (hereinafter referred to as “nonaqueous electrolyte secondary battery separator”) which nonaqueous electrolyte secondary battery separator has excellent heat resistance, a porous layer including an organic filler has been developed. For example, Patent Literature 1 discloses a battery separator that is a laminated porous film including (i) a polyolefin porous base material and (ii) a porous layer which is provided on at least one surface of the polyolefin porous base material and which includes, as necessary constituent elements, an organic filler and a binder resin.

### CITATION LIST

### Patent Literature

[Patent Literature 1]

Pamphlet of International Publication No. WO2013/154090 (Publication Date: Oct. 17, 2013)

### SUMMARY OF INVENTION

### Technical Problem

However, a nonaqueous electrolyte secondary battery porous layer including a conventional organic filler still has room for improvement in terms of high-temperature constant-voltage charge preservability of a nonaqueous electrolyte secondary battery after charging (i.e., preservability in a case where the battery is kept charged at a constant voltage at a high temperature).

### Solution to Problem

The present invention encompasses any of aspects described in the following [1] through [7].

[1] A porous layer including: an organic filler; and a resin,

an inclination of a straight line on a TG chart of the organic filler, which straight line connects a point at 150° C. and a point at a TG inflection point temperature, being not less than −0.10% by mass/° C.,

an amount of the organic filler contained in the porous layer being 87% by weight to 99.5% by weight, relative to 100% by weight of the nonaqueous electrolyte secondary battery porous layer,

the TG inflection point temperature being a temperature at which the following approximation lines intersect in a case where the organic filler is subjected to a heat treatment in which a temperature is raised from 30° C. to 500° C. at a rate of 10° C./min.: (i) an approximation line derived from values between a point at 150° C. and a point at 180° C. on the TG chart with use of Microsoft (registered trademark) Excel (registered trademark) and (ii) an approximation line derived, with use of Microsoft (registered trademark) Excel (registered trademark), from values on the TG chart, which values are within a range of ±1.5° C. from a point having a mean inclination with a lowest value among mean inclinations that are derived from data at every 5 seconds from the point at 180° C. to a point at 500° C. on the TG chart with use of the SLOPE function of Microsoft (registered trademark) Excel (registered trademark).

[2] The nonaqueous electrolyte secondary battery porous layer described in [1], in which a value of D50 in a volume-based particle size distribution of the organic filler is not more than 3 μm.
[3] The nonaqueous electrolyte secondary battery porous layer described in [1] or [2], further including: at least one resin selected from the group consisting of a polyolefin, a (meth)acrylate-based resin, a fluorine-containing resin, a polyamide-based resin, a polyester-based resin, and a water-soluble polymer.
[4] The nonaqueous electrolyte secondary battery porous layer described in [3], in which the polyamide-based resin is an aramid resin.
[5] A nonaqueous electrolyte secondary battery separator including: a polyolefin porous film; and a nonaqueous electrolyte secondary battery porous layer described in any one of [1] through [4], the nonaqueous electrolyte secondary battery porous layer being disposed on one surface or both surfaces of the polyolefin porous film.
[6] A nonaqueous electrolyte secondary battery member including: a positive electrode; a nonaqueous electrolyte secondary battery porous layer described in any one of [1] through [4] or a nonaqueous electrolyte secondary battery separator described in [5]; and a negative electrode, the positive electrode, the nonaqueous electrolyte secondary battery porous layer or the nonaqueous electrolyte secondary battery separator, and the negative electrode being arranged in this order.
[7] A nonaqueous electrolyte secondary battery including: a nonaqueous electrolyte secondary battery porous layer described in any one of [1] through [4] or a nonaqueous electrolyte secondary battery separator described in [5].

### Advantageous Effects of Invention

A nonaqueous electrolyte secondary battery porous layer in accordance with an embodiment of the present invention allows for an increase in high-temperature constant-voltage charge preservability of a nonaqueous electrolyte secondary battery after charging.

### BRIEF DESCRIPTION OF DRAWINGS

FIG. 1 is a view showing a relationship (TG chart) in accordance with an embodiment of the present invention between (i) a decrease in mass of an organic filler and (ii) a heating temperature.

### DESCRIPTION OF EMBODIMENTS

The following description will discuss an embodiment of the present invention. The present invention is, however, not limited to such an embodiment. Further, the present invention is not limited to the description of the arrangements below, but may be altered in various ways by a skilled person within the scope of the claims. Any embodiment based on a proper combination of technical means disclosed in different embodiments is also encompassed in the technical scope of the present invention. Any numerical range expressed as “A to B” herein means “not less than A and not more than B” unless otherwise stated.

### Embodiment 1: Nonaqueous Electrolyte Secondary Battery Porous Layer

A nonaqueous electrolyte secondary battery porous layer in accordance with Embodiment 1 of the present invention (hereinafter also simply referred to as “porous layer”) is a nonaqueous electrolyte secondary battery porous layer including an organic filler and a resin,

an inclination of a straight line on a TG chart of the organic filler, which straight line connects a point at 150° C. and a point at a TG inflection point temperature, being not less than −0.10% by mass/° C., and an amount of the organic filler contained in the nonaqueous electrolyte secondary battery porous layer being 87% by weight to 99.5% by weight, relative to 100% by weight of the nonaqueous electrolyte secondary battery porous layer.

Note that a TG inflection point temperature is a temperature at which the following approximation lines intersect in a case where the organic filler is subjected to a heat treatment in which a temperature is raised from 30° C. to 500° C. at a rate of 10° C./min.: (i) an approximation line derived from values between a point at 150° C. and a point at 180° C. on a TG chart with use of Microsoft (registered trademark) Excel (registered trademark) and (ii) an approximation line derived, with use of Microsoft (registered trademark) Excel (registered trademark), from values on the TG chart, which values are within a range of ±1.5° C. from a point having a lowest value of mean inclinations which are derived from data at every 5 seconds from the point at 1800° C. to a point at 500° C. on the TG chart with use of SLOPE function of Microsoft (registered trademark) Excel (registered trademark).

<Nonaqueous Electrolyte Secondary Battery Porous Layer>

The porous layer in accordance with an embodiment of the present invention alone can serve as a nonaqueous electrolyte secondary battery separator in a case where, for example, the porous layer is provided on an electrode. In a case where the porous layer in accordance with an embodiment of the present invention is disposed on one surface or both surfaces of a polyolefin porous film (described later), the porous layer can serve as a member of a nonaqueous electrolyte secondary battery separator in accordance with Embodiment 2 of the present invention (described later).

The porous layer in accordance with an embodiment of the present invention has a structure in which many pores, connected to one another, are provided, so that the porous layer is a layer through which a gas or a liquid can pass from one surface to the other. Further, in a case where the porous layer in accordance with an embodiment of the present invention is used as a member included in a nonaqueous electrolyte secondary battery laminated separator, the porous layer can be a layer which, serving as an outermost layer of the separator (laminated body), comes into contact with an electrode.

The porous layer in accordance with an embodiment of the present invention includes the organic filler. Note that “organic filler” means fine particles made of organic matters. The organic filler is not limited to any particular one, provided that an inclination of a straight line, which connects a point at 150° C. and a point at a TG inflection point temperature on a TG chart, is not less than −0.10% by mass/° C. Specific examples of the organic matters constituting the organic filler encompass: resorcin-formalin resin (RF resin); fluorine-containing resins such as polytetrafluoroethylene, an ethylene tetrafluoride-propylene hexafluoride copolymer, an ethylene tetrafluoride-ethylene copolymer, and polyvinylidene fluoride; melamine resin; and urea resin.

The organic filler can be made of one kind of organic matter or can be made of a mixture of two or more kinds of organic matters.

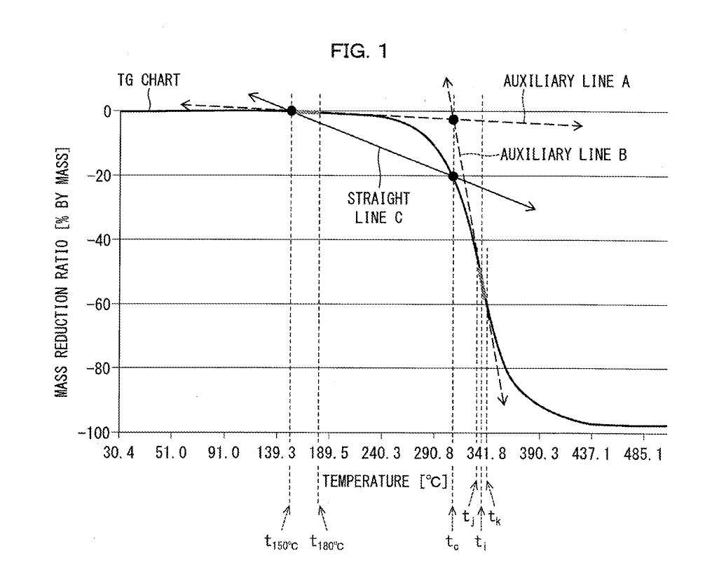

An “inclination of a straight line connecting a point at 150° C. and a point at a TG inflection point temperature on a TG chart of an organic filler” in accordance with an embodiment of the present invention (hereinafter also referred to as “inclination in accordance with an embodiment of the present invention”) and a method of calculating the inclination will be described below with reference to FIG. 1.

A TG chart of FIG. 1 shows a curve indicating an amount of change (amount of decrease) in mass of an organic filler by heating in a case where the organic filler is subjected to a heat treatment in which a temperature of the organic filler is raised from 30° C. to 500° C. at a rate of 10° C./min., where (i) the vertical axis indicates a heating temperature t (° C.) and (ii) the horizontal axis indicates a mass reduction ratio, that is, a change ratio (% by mass) of the mass of the organic filler at t (° C.) to the mass of the organic filler at a start of the measurement (heating). Note that the mass of the organic filler ordinarily decreases by heating. This causes the ratio in the change of the mass of the organic filler at t° C. to be a negative value.

According to an embodiment of the present invention, “a point at a temperature t° C. on a TG chart” means a point on a TG chart having an axis of a mass reduction ratio (% by mass) axis and an axis of a temperature (° C.) axis, which point indicates the mass reduction ratio in a case where the temperature is t° C.

Specifically, an inflection point temperature in accordance with an embodiment of the present invention is calculated by a method including the following steps:

(a) An approximation line is derived from values from a point at 150° C. to a point at 180° C. on the TG chart with use of Microsoft (registered trademark) Excel (registered trademark). Specifically, a straight line (auxiliary line A shown in FIG. 1) on a TG chart, which straight line approximates all pieces of data existing between a point in a case where the temperature t is 150° C. and a point in a case where the temperature t is 180° C., is derived with use of the “approximation line” function of Microsoft (registered trademark) Excel (registered trademark).
(b) From the data from the point at 180° C. to the point at 500° C. on the TG chart, that is, from all data on the TG chart ranging from the data in the case where the temperature t is 180° C. to the data in the case where the temperature t is 500° C., mean inclinations of every 5 seconds (i.e. 10 pieces of data at sampling intervals of 0.5 seconds) are derived with use of the SLOPE function of MICROSOFT (registered trademark) Excel (registered trademark).
(c) A point on the TG chart, which point has a mean inclination with a lowest value among the mean inclinations derived in the step (b), is determined, and a heating temperature at the point is used as tᵢ.

Then, by the following steps (d) through (f), an approximation line is derived, with use of the “approximation line” function of Microsoft (registered trademark) Excel (registered trademark), from values within a range of ±1.5° C. from a point on the TG chart, and then a TG inflection point temperature is obtained.

(d) In FIG. 1, with the heating temperature tᵢ (calculated in the step (c)) as a reference, a heating temperature tⱼ (which is 1.5° C. lower than tᵢ) and a heating temperature tₖ (which is 1.5° C. higher than tᵢ) are calculated.
(e) An approximation line (auxiliary line B in FIG. 1), which approximates all pieces of data on the TG chart between a point at the heating temperature tⱼ (calculated in the step (d)) and a point at the heating temperature tₖ (calculated in the step (d)), is derived with use of the “approximation line” function of Microsoft (registered trademark) Excel (registered trademark).
(f) A heating temperature t_{c}, at which the approximation line (auxiliary line A in FIG. 1) derived in the step (a) and the approximation line (auxiliary line B in FIG. 1) derived in the step (e) intersect, is used as the TG inflection point temperature.

An inclination in accordance with an embodiment of the present invention is an inclination of a straight line (straight line C in FIG. 1) connecting a point at a heating temperature t_{150° C.} and a point at a heating temperature t_{c} on a TG chart.

It is known that an organic filler in accordance with an embodiment of the present invention is decomposed by heating to a decomposition temperature. Meanwhile, at a high temperature (e.g., 55° C.), even at a temperature less than the decomposition temperature, side reactions such as a decomposition reaction and a solid-gas reaction occur in a part of organic matters constituting the organic filler (i.e., a part of resin skeleton of the organic filler) and in impurities contained in the organic filler. This causes the mass of the organic filler to be decreased. An “inclination in accordance with an embodiment of the present invention” is an index indicative of a degree of a decrease in the mass of the organic filler due to the side reactions.

In an embodiment of the present invention, a greater inclination (i.e., a smaller absolute value of the inclination) indicates a smaller decrease in the mass of the organic filler, which decrease occurs due to the side reactions. Meanwhile, a less “inclination in accordance with an embodiment of the present invention” (i.e., a larger absolute value of the inclination) indicates a larger decrease in the mass of the organic filler, which decrease occurs due to the side reactions.

In a case where a nonaqueous electrolyte secondary battery including a porous layer including an organic filler is stored at a high temperature (e.g., 55° C.) after charging, the side reactions occur. The side reactions consume energy. Therefore, in a case where a conventional nonaqueous electrolyte secondary battery is stored at a high temperature after initial charging, (i) a voltage decreases or (ii) it is necessary to continue charging the battery for maintaining a constant voltage.

In a case where the “inclination in accordance with an embodiment of the present invention” is not less than −0.10% by mass/° C., the occurrence of the side reactions is restricted in a case where a battery is stored at a high temperature after charging. This (i) allows for a reduction in the amount of decrease in voltage during the storage and (ii) makes it possible reduce the amount of electric current which is necessary for maintaining a constant voltage. Therefore, a porous layer in accordance with an embodiment of the present invention allows a nonaqueous electrolyte secondary battery, which includes the porous layer, to improve in preservability at a high temperature after charging.

In view of the description above, an “inclination in accordance with an embodiment of the present invention” is preferably not less than −0.097% by mass/° C. and more preferably not less than −0.050% by mass/° C.

The porous layer in accordance with an embodiment of the present invention further includes a resin in addition to the organic filler. The resin can serve as a binder resin to (i) bind fine particles of the organic filler to each other, (ii) bind the organic filler to an electrode, and (iii) bind the organic filler to a porous film (porous base material).

The resin is preferably (i) insoluble in a nonaqueous electrolyte of a nonaqueous electrolyte secondary battery and (ii) electrochemically stable when the nonaqueous electrolyte secondary battery is in normal use. Specific examples of the resin encompass: polyolefins such as polyethylene, polypropylene, polybutene, and an ethylene-propylene copolymer; a (meth)acrylate-based resin; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; a fluorine-containing rubber having a glass transition temperature of equal to or less than 23° C., among the fluorine-containing resins; polyamide-based resins such as aramid resins such as aromatic polyamide and wholly aromatic polyamide; polyester-based resins such as (i) aromatic polyester such as polyarylate and (ii) liquid crystal polyester; rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins with a melting point or glass transition temperature of not lower than 180° C. such as polyphenylene ether, polysulfone, polyether sulfone, polyphenylene sulfide, polyetherimide, polyamide imide, and polyether amide; water-soluble polymers such as polyvinyl alcohol, polyethylene glycol, cellulose ether, sodium alginate, polyacrylic acid, polyacrylamide, and polymethacrylic acid; and polycarbonate, polyacetal, and polyether ether ketone.

Alternatively, a water-insoluble polymer can be suitably used as the resin contained in the porous layer in accordance with an embodiment of the present invention. In other words, the porous layer in accordance with an embodiment of the present invention, which contains the water-insoluble polymer (e.g., acrylate resin) as the resin and the organic filler, is produced preferably with use of an emulsion obtained by dispersing the water-insoluble polymer in an aqueous solvent.

Note that the water-insoluble polymer means a polymer that does not dissolve in an aqueous solvent but becomes particles so as to be dispersed in an aqueous solvent. “Water-insoluble polymer” means a polymer which has an insoluble content of not less than 90% by weight in a case where 0.5 g of the polymer is mixed with 100 g of water at 25° C. Meanwhile, the “water-soluble polymer” refers to a polymer which has an insoluble content of less than 0.5% by weight in a case where 0.5 g of the polymer is mixed with 100 g of water at 25° C. The shape of the particles of the water-insoluble polymer is not limited to any particular one, but is preferably a spherical shape.

The water-insoluble polymer is produced as polymer particles by, for example, polymerizing, in an aqueous solvent, a monomer composition containing a monomer (described later).

Examples of the monomer constituting the water-insoluble polymer encompass styrene, vinyl ketone, acrylonitrile, methyl methacrylate, ethyl methacrylate, glycidyl methacrylate, glycidyl acrylate, methyl acrylate, ethyl acrylate, and butyl acrylate.

The aqueous solvent contains water, and is not limited to any particular one, provided that the water-insoluble polymer particles can be dispersed in the aqueous solvent.

The aqueous solvent can contain an organic solvent which can be dissolved in water at any ratio to the water. Examples of such an organic solvent encompass methanol, ethanol, isopropyl alcohol, acetone, tetrahydrofuran, acetonitrile, and N-methylpyrrolidone. The aqueous solvent can also contain (i) a surfactant such as sodium dodecylbenzene sulfonate, (ii) a dispersing agent such as a polyacrylic acid or a sodium salt of carboxymethyl cellulose, and/or (iii) the like.

Note that the porous layer in accordance with an embodiment of the present invention can contain a single kind of resin or can contain a mixture of two or more kinds of resins.

Specific examples of the aramid resin encompass poly(paraphenylene terephthalamide), poly(methaphenylene isophthalamide), poly(parabenzamide), poly(metabenzamide), poly(4,4′-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), a paraphenylene terephthalamide/2,6-dichloroparaphenylene terephthalamide copolymer, and a methaphenylene terephthalamide/2,6-dichloroparaphenylene terephthalamide copolymer. Among these aromatic polyamides, poly(paraphenylene terephthalamide) is more preferable.

Among the above resins, a polyolefin, a (meth)acrylate-based resin, a fluorine-containing resin, a polyamide-based resin, a polyester-based resin, a water-soluble polymer, or the water-insoluble polymer in the form of particles dispersed in the aqueous solvent is more preferable. Among these resins, in a case where the porous layer is arranged so as to face a positive electrode, a fluorine-containing resin is still more preferable, and a polyvinylidene fluoride-based resin is particularly preferable. This is because such a resin makes it easy to maintain various properties, such as a rate characteristic and a resistance characteristic (solution resistance), of a nonaqueous electrolyte secondary battery even in a case where the nonaqueous electrolyte secondary battery suffers acidic deterioration during operation of the nonaqueous electrolyte secondary battery. Examples of the polyvinylidene fluoride-based resin encompass: a homopolymer of vinylidene fluoride (that is, polyvinylidene fluoride); and a copolymer of vinylidene fluoride and at least one monomer selected from the group consisting of hexafluoropropylene, tetrafluoroethylene, trifluoroethylene, trichloroethylene, and vinyl fluoride is particularly preferable.

Further, the water-soluble polymer or the water-insoluble polymer which is in the form of particles dispersed in the aqueous solvent is more preferable in view of a process and an environmental impact, because water can be used as a solvent to form the porous layer. The water-soluble polymer is still more preferably cellulose ether or sodium alginate, and particularly preferably cellulose ether.

Specific examples of the cellulose ether encompass carboxymethyl cellulose (CMC), hydroxyethyl cellulose (HEC), carboxyethyl cellulose, methyl cellulose, ethyl cellulose, cyanoethyl cellulose, and oxyethyl cellulose. The cellulose ether is more preferably CMC or HEC, and particularly preferably CMC, because CMC and HEC degrade less over an extended period of time of use and are excellent in chemical stability.

In view of adhesiveness of particles of an organic filler, the water-insoluble polymer in the form of particles dispersed in the aqueous solvent is preferably a homopolymer of an acrylate monomer, such as methyl methacrylate, ethyl methacrylate, glycidyl methacrylate, glycidyl acrylate, methyl acrylate, ethyl acrylate, or butyl acrylate. Alternatively, the water-insoluble polymer is preferably a copolymer of two or more kinds of the monomers.

A lower limit value of the amount of the resin contained in the porous layer in accordance with an embodiment of the present invention is preferably not less than 0.5% by weight, not less than 1% by weight, or not less than 2% by weight, relative to 100% by weight of the porous layer. Meanwhile, an upper limit value of the amount of the resin contained in the porous layer in accordance with an embodiment of the present invention is preferably not more than 13% by weight or not more than 10% by weight, relative to 100% by weight of the porous layer. The amount of the resin contained is preferably not less than 0.5% by weight, in view of the fact that such a content improves adhesion of particles of an organic filler, that is, in view of prevention of the organic filler from falling off from the porous layer. The amount of the resin contained is preferably not more than 13% by weight, in view of a battery characteristic (particularly resistance to ion permeation) and heat resistance.

The amount of the organic filler contained in the porous layer in accordance with an embodiment of the present invention is preferably not less than 87% by weight or not less than 90% by weight, relative to 100% by weight of the porous layer. The amount of the organic filler contained is preferably not more than 99.5% by weight, not more than 99% by weight, or not more than 98% by weight, relative to 100% by weight of the porous layer.

In a case where the amount of the organic filler contained is not less than 87% by weight, the porous layer has excellent heat resistance. In a case where the amount of the organic filler contained is not more than 99.5% by weight, the porous layer has excellent adhesion between particles of the filler. A nonaqueous electrolyte secondary battery separator, which includes the porous layer containing such an organic filler, can have improved slidability and heat resistance.

According to the porous layer in accordance with an embodiment of the present invention, a value of D50 in a volume-based particle size distribution of the organic filler (hereinafter also simply referred to “D50”) is preferably not more than 3 μm, and more preferably not more than 1 μm. D50 of the organic filler is preferably not less than 0.01 μm, more preferably not less than 0.05 μm, and still more preferably not less than 0.1 μm.

In a case where D50 of the organic filler included in the porous layer in accordance with an embodiment of the present invention falls within the above preferable ranges, it is possible to (i) secure good adhesiveness, good slidability, and good air permeability of the porous layer and (ii) impart excellent formability to the porous layer.

The organic filler can have any shape and is not limited to any particular shape. The organic filler can be, for example, a particulate filler. Example of the shape of particles of the organic filler encompass: a spherical shape; an elliptical shape; a plate-like shape; a bar shape; an irregular shape; a fibrous shape; and shapes, such as a peanut-like shape and a tetrapod-like shape, which are formed by bonding of particles having spherical shapes or pillar shapes.

The porous layer in accordance with an embodiment of the present invention can include a component other than the organic filler and the resin. Such a component can be, for example, an inorganic filler. Examples of the inorganic filler encompass talc, clay, kaolin, silica, hydrotalcite, diatomaceous earth, magnesium carbonate, barium carbonate, magnesium sulfate, barium sulfate, aluminum hydroxide, magnesium hydroxide, magnesium oxide, titanium oxide, alumina, mica, zeolite, glass, calcium carbonate, calcium sulfate, and calcium oxide.

Only one kind of inorganic filler can be contained, or a mixture of two or more kinds of inorganic fillers can be contained.

Examples of the component other than the organic filler and the resin further encompass a surfactant and wax. Such a component is contained in an amount of preferably 0% by weight to 10% by weight, relative to 100% by weight of the porous layer.

The porous layer in accordance with an embodiment of the present invention has a thickness of preferably 0.5 μm to 10 μm (per layer), and more preferably 1 μm to 5 μm (per layer), in order to secure (i) adhesiveness of the porous layer to an electrode and (ii) a high energy density.

In view of ion permeability, the porous layer in accordance with an embodiment of the present invention preferably has a sufficiently porous structure. Specifically, the porous layer preferably has a porosity of 30% to 60%.

The porosity can be calculated by, for example, the following formula, where (i) W is a weight (g) of a porous layer having a certain volume (8 cm×8 cm×d (cm) (d: thickness)), (ii) the thickness d (μm) of the porous layer, and (iii) ρ (g/cm³) is an absolute specific gravity of the porous layer:

Porosity (%)=(1−{(W/φ/(8×8×d)})×100

Furthermore, the porous layer in accordance with an embodiment of the present invention has an average pore diameter of preferably 20 nm to 100 nm.

The average pore diameter can be calculated by, for example, (i) observing the porous layer in accordance with an embodiment of the present invention from a top surface with use of a scanning electron microscope (SEM), (ii) measuring a pore diameters of a plurality of voids randomly selected, and (iii) obtaining an average value of the pore diameters thus measured.

<Method of Producing Nonaqueous Electrolyte Secondary Battery Porous Layer>

A method of producing the porous layer in accordance with an embodiment of the present invention is not limited to any particular one. For example, it is possible to use a method in which a porous layer containing the organic filler and the resin is formed on a base material by carrying out any one of the following processes (1) to (3). In a case where the following process (2) or (3) is carried out, a porous layer can be produced by further drying a deposited resin so as to remove a solvent. In a coating solution used in each of the processes (1) through (3), the organic filler may be dispersed and the resin may be dissolved. Examples of the base material encompass, but are not particularly limited to, (i) a polyolefin porous film which serves as a base material of a nonaqueous electrolyte secondary battery separator (described later) in accordance with an embodiment of the present invention or (ii) an electrode sheet.

(1) A process in which (i) a base material is coated with a coating solution, which is to form the porous layer and contains the organic filler and the resin, and then (ii) the base material is dried for removal of a solvent (dispersion medium) from the coating solution, so that the porous layer is formed.

(2) A process in which (i) the base material is coated with a coating solution, which is to form the porous layer and contains the organic filler and the resin, and then (ii) the base material is immersed into a deposition solvent (which is a poor solvent for the above resin) so that the porous layer is formed by deposition of the organic filler and the resin.

(3) A process in which (i) the base material is coated with a coating solution, which is to form the porous layer and contains the organic filler and the resin, and then (ii) the coating solution is made acidic with use of a low-boiling-point organic acid so that the porous layer is formed by deposition of the organic filler and the resin.

The solvent (dispersion medium) in the coating solution is not limited to any particular one, provided that (i) the solvent does not adversely affect the base material, (ii) the solvent allows the resin to be dissolved or dispersed in the solvent uniformly and stably, and (iii) the solvent allows the organic filler to be dispersed in the solvent uniformly and stably. Examples of the solvent (dispersion medium) encompass N-methylpyrrolidone, N,N-dimethylacetamide, N,N-dimethylformamide, acetone, and water.

The deposition solvent can be, for example, another solvent (hereinafter also referred to as “solvent X”) which is soluble in the solvent (dispersion medium) contained in the coating solution and which does not dissolve the resin contained in the coating solution. The solvent (dispersion medium) can be efficiently removed from the coating solution by (i) immersing the base material (on which a coating film has been formed by coating the base material with the coating solution) in the solvent X, so that a solvent (dispersion medium) in the coating film on the base material or a support is replaced with the solvent X and (ii) evaporating the solvent X. Preferable examples of the deposition solvent encompass isopropyl alcohol and t-butyl alcohol.

For the process (3), the low-boiling-point organic acid can be, for example, paratoluene sulfonic acid or acetic acid.

In view of adhesiveness of the porous layer to an electrode (electrode sheet) and ion permeability of the porous layer, a coating amount (weight per unit area) of the porous layer per layer of the porous layer is, typically, preferably 0.5 g/m² to 20 g/m², more preferably 0.5 g/m² to 10 g/m², and still more preferably 0.5 g/m² to 5 g/m², in terms of solid content. That is, an amount of the coating solution to be applied to the base material is preferably adjusted so that the porous layer to be obtained will have a coating amount (weight per unit area) within the above ranges.

In any of the processes (1) through (3), in a case where a change is made to the amount of resin which is to form a porous layer and which is dissolved or dispersed in a solution, it is possible to adjust the volume of resin which is contained per square meter of a porous layer having undergone immersion in an electrolyte and which has absorbed the electrolyte.

Further, in a case where a change is made to the amount of solvent in which the resin for forming the porous layer is to be dissolved or dispersed, it is possible to adjust the porosity and average pore diameter of a porous layer having undergone immersion in an electrolyte.

A suitable solid content concentration of the coating solution may vary depending on, for example, the kind of the inorganic filler. In general, the solid content concentration is preferably more than 20% by weight and not more than 40% by weight.

When the base material is coated with the coating solution, a coating shear rate may vary depending on, for example, the kind of the inorganic filler. In general, the coating shear rate is preferably not less than 2 (1/s) and more preferably 4 (1/s) to 50 (1/s).

Note that an “inclination in accordance with an embodiment of the present invention” can be increased by subjecting the organic filler to a pretreatment or adjusting production conditions for producing the organic filler, before the coating solution is prepared. Examples of the pretreatment encompass a purification treatment and a firing treatment. The “inclination in accordance with an embodiment of the present invention” can be increased by carrying out the pretreatment so as to (i) reduce the amount of impurities contained in the organic filler and (ii) remove a part which can easily be decomposed by application of heat.

### Embodiment 2: Nonaqueous Electrolyte Secondary Battery Separator

A nonaqueous electrolyte secondary battery separator in accordance with Embodiment 2 of the present invention includes (i) a polyolefin porous film and (ii) a nonaqueous electrolyte secondary battery porous layer in accordance with Embodiment 1 of the present invention which is disposed on one surface or both surfaces of the polyolefin porous film. Hereinafter, the nonaqueous electrolyte secondary battery separator in accordance with Embodiment 2 of the present invention will also be referred to as “nonaqueous electrolyte secondary battery laminated separator”.

<Porous Film>

The porous film in accordance with an embodiment of the present invention can be a base material for a nonaqueous electrolyte secondary battery laminated separator in accordance with an embodiment of the present invention. The porous film contains a polyolefin-based resin as a main component. The porous film has therein many pores which are connected to one another, so that a gas, a liquid, or the like can pass through the porous film from one surface to the other. The porous film can include a single layer or a plurality of layers which are disposed on top of each other.

The expression that a “porous film contains a polyolefin-based resin as a main component” means that the polyolefin-based resin accounts for not less than 50% by volume, preferably not less than 90% by volume, and more preferably not less than 95% by volume, of the entire porous film. The polyolefin-based resin more preferably contains a high molecular weight component having a weight-average molecular weight of 3×10⁵ to 15×10⁶. In particular, the polyolefin more preferably contains a high molecular weight component having a weight-average molecular weight of not less than 1,000,000. This is because, in such a case, there is an increase in strength of a nonaqueous electrolyte secondary battery laminated separator in accordance with an embodiment of the present invention, which is a laminated body in which a nonaqueous electrolyte secondary battery porous layer in accordance with an embodiment of the present invention is disposed on one surface or both surfaces of the porous film.

Examples of the polyolefin-based resin which is a main component of the porous film encompass, but are not particularly limited to, homopolymers (such as polyethylene, polypropylene, and polybutene) and copolymers (such as an ethylene-propylene copolymer), any of which is obtained through (co)polymerization of a monomer such as ethylene, propylene, 1-butene, 4-methyl-1-pentene, and 1-hexene (which are thermoplastic resins). Among these, polyethylene is preferable because it is capable of preventing (shutting down) a flow of an excessively large electric current at a lower temperature. Examples of the polyethylene encompass low-density polyethylene, high-density polyethylene, linear polyethylene (an ethylene-α-olefin copolymer), and ultra-high molecular weight polyethylene having a weight-average molecular weight of not less than 1,000,000. Among these, the polyethylene is more preferably (i) high molecular weight polyethylene having a weight-average molecular weight of 300,000 to 1,000,000 or (ii) ultra-high molecular weight polyethylene having a weight-average molecular weight of not less than 1,000,000. Specific examples of the polyolefin-based resin encompass a polyolefin-based resin made of a mixture of (i) a polyolefin having a weight-average molecular weight of not less than 1,000,000 and (ii) a low molecular weight polyolefin having a weight-average molecular weight of not more than 10,000.

A thickness of the porous film can be set as appropriate in view of a thickness of a laminated body which is the nonaqueous electrolyte secondary battery laminated separator in accordance with an embodiment of the present invention. The thickness of the porous film is preferably 4 μm to 40 μm (per layer) and more preferably 5 μm to 20 μm (per layer).

The porous film preferably has a thickness of not less than 4 μm (per layer). This is because, in a nonaqueous electrolyte secondary battery including a nonaqueous electrolyte secondary battery laminated separator using the porous film having such a thickness, it is possible to sufficiently prevent an internal short circuit that might occur due to, for example, breakage of the nonaqueous electrolyte secondary battery. Meanwhile, the porous film preferably has a thickness of not more than 40 μm (per layer). This is because, with such a thickness, (i) it is possible to restrict an increase in resistance to lithium ion permeation all over the nonaqueous electrolyte secondary battery laminated separator which includes the porous film, (ii) it is possible to prevent a positive electrode from deteriorating and also to prevent a rate characteristic and a cycle characteristic from decreasing in a case where a charge-discharge cycle is repeated, in a nonaqueous electrolyte secondary battery including the nonaqueous electrolyte secondary battery laminated separator, and (iii) it is possible to prevent an increase in size of the nonaqueous electrolyte secondary battery itself in a case where a distance between the positive electrode and a negative electrode increases.

The porous film has a weight per unit area which can be set as appropriate, in view of strength, a thickness, a weight, and handleability of the nonaqueous electrolyte secondary battery laminated separator including the porous film. Specifically, the weight per unit area of the porous film is, typically, preferably 4 g/m² to 20 g/m² (per layer) and more preferably 5 g/m² to 12 g/m² (per layer), so as to allow the nonaqueous electrolyte secondary battery including the nonaqueous electrolyte secondary battery laminated separator to have a higher weight energy density and a higher volume energy density.

The porous film has an air permeability of preferably 30 sec/100 mL to 500 sec/100 mL and more preferably 50 sec/100 mL to 300 sec/100 mL, in terms of Gurley values. A porous film having such an air permeability allows a nonaqueous electrolyte secondary battery laminated separator including the porous film to achieve sufficient ion permeability.

The porous film has a porosity of preferably 20% by volume to 80% by volume and more preferably 30% by volume to 75% by volume, so as to (i) retain a larger amount of an electrolyte and (ii) obtain the function of reliably preventing (shutting down) a flow of an excessively large electric current at a lower temperature. The porous film preferably has a porosity of not less than 20% by volume. This is because such a porosity makes it possible to restrict resistance of the porous film to ion permeation. Meanwhile, in view of a mechanical strength of the porous film, the porosity of the porous film is preferably not more than 80% by volume.

The porous film has a pore diameter of preferably not more than 0.3 μm and more preferably not more than 0.14 μm, so that the nonaqueous electrolyte secondary battery laminated separator including the porous film can (i) have sufficient ion permeability and (ii) prevent particles from entering the positive electrode and the negative electrode.

As necessary, the nonaqueous electrolyte secondary battery laminated separator can further include another porous layer in addition to the porous film and the porous layer in accordance with Embodiment 1 of the present invention. Examples of such another porous layer encompass publicly known porous layers such as a heat-resistant layer, an adhesive layer, and a protective layer. Specific examples of such another porous layer encompass a porous layer identical in composition to the porous layer in accordance with Embodiment 1 of the present invention.

[Method of Producing Porous Film]

A method of producing the porous film is not particularly limited, and can be, for example, a method in which (i) a pore forming agent is added to a resin such as a polyolefin so as to form a film and then (ii) the pore forming agent is removed with use of an appropriate solvent.

Specifically, in a case where, for example, the porous film is made of a polyolefin resin containing ultra-high molecular weight polyethylene and low molecular weight polyolefin which has a weight-average molecular weight of not more than 10,000, it is preferable in view of production costs that the porous film is produced by a method including:

(1) kneading 100 parts by weight of ultra-high molecular weight polyethylene, 5 parts by weight to 200 parts by weight of low molecular weight polyolefin having a weight-average molecular weight of not more than 10,000, and 100 parts by weight to 400 parts by weight of a pore forming agent, so as to obtain a polyolefin resin composition; and
(2) forming the polyolefin resin composition into a rolled sheet by rolling, then, the following steps (3) through (5):
(3) removing the pore forming agent from the rolled sheet obtained in the step (2);
(4) stretching the sheet from which the pore forming agent has been removed in the step (3); and
(5) heat fixing the sheet having been stretched in the step (4) at a heat-fixation temperature of 100° C. to 150° C., so as to obtain a porous film, or
the following steps (3′) through (5′):
(3′) stretching the rolled sheet obtained in the step (2);
(4′) removing the pore forming agent from the sheet having been stretched in the step (3′); and
(5′) heat fixing the sheet having been obtained in the step (4′) at a heat-fixation temperature of 100° C. to 150° C., so as to obtain a porous film.

Examples of the pore forming agent encompass an inorganic bulking agent and a plasticizer.

Examples of the inorganic bulking agent encompass, but are not particularly limited to, an inorganic filler. Examples of the plasticizer encompass, but are not particularly limited to, a low molecular weight hydrocarbon such as liquid paraffin.

<Method of Producing Nonaqueous Electrolyte Secondary Battery Laminated Separator>

A method of producing the nonaqueous electrolyte secondary battery laminated separator in accordance with an embodiment of the present invention can be, for example, the above-described method of producing the porous layer in which porous film is used as a base material which is coated with the coating solution.

As described above, the nonaqueous electrolyte secondary battery laminated separator is obtained so that the porous layer is disposed on one surface or both surfaces of the polyolefin porous film.

### Embodiment 3: Nonaqueous Electrolyte Secondary Battery Member, and Embodiment 4: Nonaqueous Electrolyte Secondary Battery

A member for a nonaqueous electrolyte secondary battery (hereinafter referred to as “nonaqueous electrolyte secondary battery member”) in accordance with Embodiment 3 of the present invention is obtained by arranging a positive electrode, a porous layer in accordance with Embodiment 1 of the present invention or a nonaqueous electrolyte secondary battery laminated separator in accordance with Embodiment 2 of the present invention, and a negative electrode, the positive electrode, the porous layer or the nonaqueous electrolyte secondary battery laminated separator, and the negative electrode being arranged in this order.

A nonaqueous electrolyte secondary battery in accordance with Embodiment 4 of the present invention includes (i) a porous layer in accordance with Embodiment 1 of the present invention or (ii) a nonaqueous electrolyte secondary battery laminated separator in accordance with Embodiment 2 of the present invention.

The nonaqueous electrolyte secondary battery in accordance with an embodiment of the present invention is, for example, a nonaqueous secondary battery that achieves an electromotive force through doping with and dedoping of lithium, and is a lithium-ion secondary battery that includes a nonaqueous electrolyte secondary battery member including a positive electrode, a porous layer in accordance with an embodiment of the present invention, a porous film, and a negative electrode, which are disposed in this order, that is, a lithium-ion secondary battery that includes a positive electrode, a nonaqueous electrolyte secondary battery laminated separator in accordance with an embodiment of the present invention, and a negative electrode, which are disposed in this order. Note that constituent elements of the nonaqueous electrolyte secondary battery other than the porous layer are not limited to those described below.

The nonaqueous electrolyte secondary battery in accordance with an embodiment of the present invention is typically configured so that a battery element is enclosed in an exterior member, the battery element including (i) a structure in which the negative electrode and the positive electrode face each other through the porous layer in accordance with an embodiment of the present invention or the nonaqueous electrolyte secondary battery laminated separator in accordance with an embodiment of the present invention and (ii) an electrolyte with which the structure is impregnated. The nonaqueous electrolyte secondary battery in accordance with an embodiment of the present invention is preferably a secondary battery including a nonaqueous electrolyte, and is particularly preferably a lithium-ion secondary battery. Note that the doping means occlusion, support, adsorption, or insertion, and means a phenomenon in which lithium ions enter an active material of an electrode (such as a positive electrode).

A nonaqueous electrolyte secondary battery member in accordance with an embodiment of the present invention includes a porous layer in accordance with an embodiment of the present invention, which porous layer has an “inclination in accordance with an embodiment of the present invention” of not less than −0.10% by mass/° C. This advantageously allows a nonaqueous electrolyte secondary battery, which includes the nonaqueous electrolyte secondary battery member, to have an improved high-temperature constant-voltage charge preservability. A nonaqueous electrolyte secondary battery in accordance with an embodiment of the present invention includes a porous layer in accordance with an embodiment of the present invention, which porous layer has an “inclination in accordance with an embodiment of the present invention” of not less than −0.10% by mass/° C. This advantageously allows the nonaqueous electrolyte secondary battery to have an excellent high-temperature constant-voltage charge preservability.

<Positive Electrode>

A positive electrode included in the nonaqueous electrolyte secondary battery member in accordance with an embodiment of the present invention or in the nonaqueous electrolyte secondary battery in accordance with an embodiment of the present invention is not limited to any particular one, provided that the positive electrode is one that is generally used as a positive electrode of a nonaqueous electrolyte secondary battery. Examples of the positive electrode encompass a positive electrode sheet having a structure in which an active material layer including a positive electrode active material and a binder resin is formed on a current collector. The active material layer can further include an electrically conductive agent.

The positive electrode active material is, for example, a material capable of being doped with and dedoped of lithium ions. Specific examples of such a material encompass a lithium complex oxide containing at least one transition metal such as V, Mn, Fe, Co, or Ni. Among such lithium complex oxides, the following lithium complex oxides have a high average discharge potential and are therefore preferable: (i) a lithium complex oxide having an α-NaFeO₂ structure, such as lithium nickelate or lithium cobaltate and (ii) a lithium complex oxide having a spinel structure, such as lithium manganese spinel. The lithium complex oxide can further contain any of various metal elements, and is more preferably a complex lithium nickelate.

Furthermore, the lithium nickel complex oxide still more preferably contains at least one metallic element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to the sum of the number of moles of the at least one metal element and the number of moles of Ni in the lithium nickelate. This is because such a complex lithium nickelate leads to an excellent cycle characteristic when used in a high-capacity battery. Among others, an active material that contains Al or Mn and that further contains Ni at a proportion of not less than 85%, and more preferably not less than 90%, is particularly preferable. This is because a nonaqueous electrolyte secondary battery including a positive electrode containing such an active material has an excellent cycle characteristic in high-capacity use.

Examples of the electrically conductive agent encompass carbonaceous materials such as natural graphite, artificial graphite, cokes, carbon black, pyrolytic carbons, carbon fiber, and a fired product of an organic polymer compound. It is possible to use (i) only one kind of the above electrically conductive agents or (ii) two or more kinds of the above electrically conductive agents in combination, for example, a mixture of artificial graphite and carbon black.

Examples of the binding agent encompass: thermoplastic resins such as polyvinylidene fluoride, a copolymer of vinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, a thermoplastic polyimide, polyethylene, and polypropylene; acrylic resin; and styrene butadiene rubber. Note that the binding agent also serves as a thickener.

Examples of a method of preparing a positive electrode mix encompasses: a method in which pressure is applied to the positive electrode active material, the electrically conductive agent, and the binding agent (binder resin) on a positive electrode current collector; and a method in which an appropriate organic solvent is used so that the positive electrode active material, the electrically conductive agent, and the binding agent will be in a paste form.

Examples of the positive electrode current collector encompass electric conductors such as Al, Ni, and stainless steel. Among these, Al is preferable because Al is easily processed into a thin film and is inexpensive.

The positive electrode sheet may be produced, that is, the positive electrode mix may be supported by the positive electrode current collector, by for example, a method in which pressure is applied to the positive electrode active material, the electrically conductive agent, and the binding agent on the positive electrode current collector to form a positive electrode mix thereon or a method in which (i) an appropriate organic solvent is used so that the positive electrode active material, the electrically conductive agent, and the binding agent will be in a paste form to provide a positive electrode mix, (ii) the positive electrode mix is applied to the positive electrode current collector, (iii) the applied positive electrode mix is dried so that a sheet-shaped positive electrode mix is prepared, and (iv) then pressure is applied to the sheet-shaped positive electrode mix so that the sheet-shaped positive electrode mix is firmly fixed to the positive electrode current collector.

<Negative Electrode>

A negative electrode included in the nonaqueous electrolyte secondary battery member in accordance with an embodiment of the present invention or in the nonaqueous electrolyte secondary battery in accordance with an embodiment of the present invention is not limited to any particular one, provided that the negative electrode is one that is generally used as a negative electrode of a nonaqueous electrolyte secondary battery. Examples of the negative electrode encompass a negative electrode sheet having a structure in which an active material layer including a negative electrode active material and a binder resin is formed on a current collector. The active material layer can further include an electrically conductive agent.

Examples of the negative electrode active material encompass (i) a material capable of being doped with and dedoped of lithium ions, (ii) a lithium metal, and (iii) a lithium alloy. Specific examples of the material encompass: carbonaceous materials such as natural graphite, artificial graphite, cokes, carbon black, pyrolytic carbons, carbon fiber, and a fired product of an organic polymer compound; chalcogen compounds such as an oxide and a sulfide that are doped with and dedoped of lithium ions at an electric potential lower than that for the positive electrode; metals such as aluminum (Al), lead (Pb), tin (Sn), bismuth (Bi), or silicon (Si), each of which is alloyed with alkali metal; cubic intermetallic compounds (AlSb, Mg₂Si, and NiSi₂) having lattice spaces in which alkali metals can be provided; and lithium nitrogen compounds (Li₃₋ₓMₓN (where M represents a transition metal)). Among the above negative electrode active materials, a carbonaceous material that contains, as a main component, a graphite material such as natural graphite or artificial graphite is preferable. This is because such a carbonaceous material is high in potential evenness, and a great energy density can be obtained in a case where the carbonaceous material, which is low in average discharge potential, is combined with the positive electrode. The negative electrode active material can alternatively be a mixture of graphite and silicon, preferably containing Si at a proportion of not less than 5%, and more preferably not less than 10%, with respect to carbon (C) constituting the graphite.

The negative electrode mix can be prepared by, for example, a method in which pressure is applied to the negative electrode active material on a negative electrode current collector or a method in which an appropriate organic solvent is used so that the negative electrode active material will be in a paste form.

Examples of the negative electrode current collector encompass electric conductors such as Cu, Ni, and stainless steel. Among these, Cu is preferable because it is not easily alloyed with lithium in the case of a lithium-ion secondary battery in particular and is easily processed into a thin film.

The negative electrode sheet may be produced, that is, the negative electrode mix may be supported by the negative electrode current collector by, for example, a method in which pressure is applied to the negative electrode active material on the negative electrode current collector to form a negative electrode mix thereon or a method in which (i) an appropriate organic solvent is used so that the negative electrode active material will be in a paste form to provide a negative electrode mix, (ii) the negative electrode mix is applied to the negative electrode current collector, (iii) the applied negative electrode mix is dried so that a sheet-shaped negative electrode mix is prepared, and (iv) then pressure is applied to the sheet-shaped negative electrode mix so that the sheet-shaped negative electrode mix is firmly fixed to the negative electrode current collector. The above paste preferably includes the above electrically conductive agent and the binding agent.

<Nonaqueous Electrolyte>

A nonaqueous electrolyte for use in the nonaqueous electrolyte secondary battery in accordance with an embodiment of the present invention is a nonaqueous electrolyte generally used in a nonaqueous electrolyte secondary battery, and is not limited to any particular one.

Examples of the nonaqueous electrolyte encompass a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination. It is preferable to use, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Specific examples of the organic solvent in the nonaqueous electrolyte in an embodiment of the present invention encompass: carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into any of the organic solvents described above. It is possible to use only one kind of the above organic solvents or two or more kinds of the above organic solvents in combination. Among the above organic solvents, carbonates are preferable. A mixed solvent of a cyclic carbonate and an acyclic carbonate or a mixed solvent of a cyclic carbonate and an ether is more preferable. The mixed solvent of a cyclic carbonate and an acyclic carbonate is still more preferably a mixed solvent of ethylene carbonate, dimethyl carbonate, and ethyl methyl carbonate. This is because such a mixed solvent leads to a wider operating temperature range, and is not easily decomposed even in a case where a negative electrode active material is a graphite material such as natural graphite or artificial graphite.

<Nonaqueous Electrolyte Secondary Battery Member Production Method and Nonaqueous Electrolyte Secondary Battery Production Method>

A nonaqueous electrolyte secondary battery member in accordance with an embodiment of the present invention can be produced by, for example, arranging a positive electrode, a porous layer in accordance with an embodiment of the present invention or a nonaqueous electrolyte secondary battery laminated separator in accordance with an embodiment of the present invention, and a negative electrode in this order.

A nonaqueous electrolyte secondary battery in accordance with an embodiment of the present invention can be produced by, for example, (i) producing a nonaqueous electrolyte secondary battery member as described above, (ii) inserting the nonaqueous electrolyte secondary battery member into a container that will serve as a housing of a nonaqueous electrolyte secondary battery, (iii) filling the container with a nonaqueous electrolyte, and (iv) hermetically sealing the container while reducing pressure inside the container.

The nonaqueous electrolyte secondary battery is not particularly limited in shape and can have any shape such as the shape of a thin plate (sheet), a disk, a cylinder, or a prism such as a cuboid. The nonaqueous electrolyte secondary battery member and the nonaqueous electrolyte secondary battery can each be produced by any method, and can each be produced by a conventionally publicly known method.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### EXAMPLES

The following description will discuss embodiments of the present invention in more detail by Examples and Comparative Examples. Note, however, that the present invention is not limited to these Examples and Comparative Examples.

[Measurement of Physical Properties]

In each of Examples and Comparative Examples, physical properties and the like of a nonaqueous electrolyte secondary battery separator, an A layer (porous film), a B layer (porous layer), and a nonaqueous electrolyte secondary battery were measured by the following methods.

(1) Thickness (unit: μm)

A thickness of the nonaqueous electrolyte secondary battery separator, a thickness of the A layer, and a thickness of the B layer were each measured with use of a high-resolution digital measuring device manufactured by Mitutoyo Corporation.

(2) Weight Per Unit Area (Unit: g/m²): A sample in the form of a 6.4 cm×4 cm rectangle was cut out from the nonaqueous electrolyte secondary battery separator, and the weight W (g) of the sample was measured. Then, the weight per unit area of the nonaqueous electrolyte secondary battery separator (i.e., weight per unit area of the entirety) was calculated in accordance with the following Formula:

Weight per unit area (g/m²)=W/(0.064×0.04)

The weight per unit area of the A layer was likewise calculated. The weight per unit area of the B layer was calculated by subtracting the weight per unit area of the A layer from the weight per unit area of the entirety.

(3) Volume-Based Particle Size Distribution: D50 (Unit: μm):

A dispersion liquid was prepared by (i) mixing, in a screw tube, a small amount of organic filler and 0.2% aqueous sodium hexametaphosphate solution and (ii) irradiating the resulting mixture with ultrasonic waves for 2 minutes.

The aqueous sodium hexametaphosphate solution was placed in a measuring quartz cell of a laser diffraction particle size analyzer (SALD-2200) manufactured by Shimadzu Corporation. While the aqueous sodium hexametaphosphate solution was being stirred, base measurement was carried out. Then, the dispersion liquid was added with use of a pipette, and then a volume-based particle size distribution D50 (D50 in a volume-based particle size distribution) of an organic filler was measured.

(4) Preparation of TG chart and calculation of “inclination in accordance with an embodiment of the present invention”

TG/DTA6200 manufactured by Hitachi High-Tech Science Corporation was used as a measuring device. An organic filler was placed on an aluminum pan so as to prepare a measurement sample. An aluminum oxide was placed on an aluminum pan so as to prepare a reference sample. The measurement sample and the reference sample were provided on the measuring device. Then, in a nitrogen atmosphere, temperatures of the measurement sample and the reference sample were raised from 30° C. to 500° C. at a rate of 10° C./min. Then, a decrease in mass of the organic filler, which decrease occurred along with the temperature rise, was measured. Then, a TG chart indicative of a relationship between a heating temperature t (° C.) and the mass reduction ratio of the organic filler was prepared. A sampling cycle for the measurement was set to 0.5 s. Based on the TG chart thus prepared, an “inclination in accordance with an embodiment of the present invention” was calculated by the above method.

(5) Constant-Voltage Charge Preservability Test (Unit: mA):

A new nonaqueous electrolyte secondary battery, which had not been subjected to any charge-discharge cycle, was subjected to four cycles of initial charge and discharge, each of the four cycles being carried out at 25° C., at a voltage ranging from 4.1 V to 2.7 V, and at an electric current value of 0.2 C (note that 1 C is an electric current value at which a battery rated capacity derived from a one-hour rate discharge capacity was discharged in one hour, and this applies to the following descriptions).

Subsequently, the nonaqueous electrolyte secondary battery was charged at 55° C., at 2.7 V to 4.2 V, and at a constant current of 1.0 C. Then, the nonaqueous electrolyte secondary battery was kept charged at a constant voltage for 168 hours. Finally, the values of electric current applied to keep the battery charged at a constant voltage were accumulated.

### Example 1

[Preparation of Nonaqueous Electrolyte Secondary Battery Separator]

<A Layer>

A porous film, which was a base material, was prepared by use of polyethylene which is a polyolefin.

Specifically, 70 parts by weight of an ultra-high molecular weight polyethylene powder (340M, manufactured by Mitsui Chemicals, Inc.) and 30 parts by weight of a polyethylene wax (FNP-0115, manufactured by Nippon Seiro Co., Ltd.) having a weight-average molecular weight of 1,000 were mixed with each other so that a mixed polyethylene was prepared. Then, with respect to 100 parts by weight of the mixed polyethylene thus obtained, 0.4 parts by weight of an antioxidant (Irg1010, manufactured by Ciba Specialty Chemicals Inc.), 0.1 parts by weight of an antioxidant (P168, manufactured by Ciba Specialty Chemicals Inc.), and 1.3 parts by weight of sodium stearate were added. Then, calcium carbonate (manufactured by Maruo Calcium Co., Ltd.) having an average particle diameter of 0.1 μm was further added so that the calcium carbonate accounted for 38% by volume of the total volume. Then, the above composition in powder form was mixed with use of a Henschel mixer, and was then melt-kneaded by a twin screw kneading extruder. This produced a polyethylene resin composition. Next, the polyethylene resin composition was rolled with use of a pair of rollers each having a surface temperature of 150° C., so that a sheet was prepared. This sheet was immersed in an aqueous hydrochloric acid solution (in which 4 mol/L of hydrochloric acid and 0.5% by weight of nonionic surfactant were mixed), so that the calcium carbonate was dissolved into the solution and removed from the sheet. Then, the sheet was stretched at 105° C. at a stretch ratio of 6 times, so that a porous film (A layer) made of polyethylene was prepared.

<B Layer>

As a binder resin, sodium carboxymethyl cellulose (CMC) (manufactured by Daicel Corporation; CMC1110) was used.

A melamine resin (EPOSTAR MS; manufactured by Nippon Shokubai Co., Ltd.) was used as an organic filler. An “inclination in accordance with an embodiment of the present invention” of the organic filler and D50 of the organic filler were measured by the above method. The results are shown in Table 2.

As a solvent, a mixed solvent, in which water and isopropyl alcohol were mixed (water:isopropyl alcohol=95% by weight:5% by weight), was used.

The organic filler, the CMC, and the solvent were mixed at the following ratio. Specifically, 6 parts by weight of the CMC was added relative to 100 parts by weight of the particles of the organic filler, and the organic filler, the CMC, and the solvent were mixed so that a solid content concentration (a total concentration of the organic filler and the CMC) would be 20.0% by weight in a resulting mixed solution. This produced a dispersion liquid of the organic filler. Then, the dispersion liquid thus obtained was dispersed by high pressure (high-pressure dispersion conditions: 100 MPa×3 passes) with use of a high-pressure dispersing device (manufactured by Sugino Machine Limited; Star Burst), so that a coating solution 1 was prepared.

One surface of the A layer was subjected to a corona treatment at 20 W/(m²/min). Then, the surface of the A layer, which surface was subjected to the corona treatment, was coated with the coating solution 1 with use of a gravure coater, so that a coating film was formed. Then, the coating film was dried, so that a nonaqueous electrolyte secondary battery porous layer (B layer) was formed. Table 2 shows the amount of the organic filler contained in the B layer (unit: % by weight) relative to 100% by weight of the B layer. This produced a laminated porous film 1 in which the B layer was disposed on the one surface of the A layer.

<Nonaqueous Electrolyte Secondary Battery Separator>

As described above, a laminated porous film 1, in which the B layer is disposed on one surface of the A layer, was obtained. The laminated porous film 1 was used as a nonaqueous electrolyte secondary battery separator 1.

<Evaluation of Physical Properties>

A thickness of the entire nonaqueous electrolyte secondary battery separator 1 obtained and a thickness and a weight per unit area of the B layer obtained were measured by the above-described method. The results of the measurement are shown in Table 1.

[Preparation of Nonaqueous Electrolyte Secondary Battery]

<Positive Electrode>

A commercially available positive electrode was used. The positive electrode was produced by coating an aluminum foil with LiNi_{0.5}Mn_{0.3}Co_{0.2}O₂/electrically conductive agent/PVDF (weight ratio 92:5:3). The aluminum foil was partially cut off so that (i) a positive electrode active material layer was present in an area of 40 mm×35 mm and (ii) the area was surrounded by an area with a width of 13 mm in which area no positive electrode active material layer was present. A piece of the aluminum foil which was cut off was used as a positive electrode. The positive electrode active material layer had a thickness of 58 μm and a density of 2.50 g/cm³.

<Negative Electrode>

A commercially available negative electrode was used. The negative electrode was produced by coating a copper foil with graphite/styrene-1,3-butadiene copolymer/sodium carboxymethyl cellulose (weight ratio 98:1:1). The copper foil was partially cut off so that (i) a negative electrode active material layer was present in an area of 50 mm×40 mm and (ii) the area was surrounded by an area with a width of 13 mm in which area no negative electrode active material layer was present. A piece of the copper foil which was cut off was used as a negative electrode. The negative electrode active material layer had a thickness of 49 μm and a density of 1.40 g/cm³.

<Nonaqueous Electrolyte Secondary Battery>

In a laminate pouch, the positive electrode, the nonaqueous electrolyte secondary battery separator 1, and the negative electrode were disposed (arranged) in this order so that (i) the B layer of the nonaqueous electrolyte secondary battery separator 1 and the positive electrode active material layer of the positive electrode are in contact with each other and (ii) the A layer of the nonaqueous electrolyte secondary battery separator 1 and the negative electrode active material layer of the negative electrode are in contact with each other. This produced a nonaqueous electrolyte secondary battery member 1. In so doing, the positive electrode and the negative electrode were arranged so that the positive electrode active material layer of the positive electrode had a main surface that was entirely covered by the main surface of the negative electrode active material layer of the negative electrode.

Subsequently, the nonaqueous electrolyte secondary battery member 1 was put into a bag made of an aluminum layer and a heat seal layer which were disposed on each other. Then, 0.23 mL of nonaqueous electrolyte was put into the bag. The nonaqueous electrolyte had been prepared by dissolving LiPF₆ in a mixed solvent in which ethylene carbonate, ethyl methyl carbonate, and diethyl carbonate were mixed at a ratio of 3:5:2 (volume ratio), so that a concentration of the LiPF₆ would become 1 mol/L. The bag was then heat-sealed while the pressure inside the bag was reduced. This produced a nonaqueous electrolyte secondary battery 1.

<Evaluation of High-Temperature Constant-Voltage Charge Preservability>

The nonaqueous electrolyte secondary battery 1 obtained was subjected to the above constant-voltage charge preservability test, and the values of electric current were measured. The values of the electric currents were accumulated, and the accumulated electric current values were used as a value of a high-temperature constant-voltage charge preservability. The results are shown in Table 2.

### Example 2

[Preparation of Nonaqueous Electrolyte Secondary Battery Separator]

<A Layer>

A porous film (A layer) made of polyethylene was prepared as in Example 1.

<B Layer>

A coating solution 2 was prepared as in Example 1 except that a melamine resin (EPOSTAR S6; manufactured by Nippon Shokubai Co., Ltd.) was used as an organic filler. An “inclination in accordance with an embodiment of the present invention” of the organic filler and D50 of the organic filler were measured by the above method. The results are shown in Table 2. Table 2 shows the amount of the organic filler contained in the B layer (unit: % by weight) relative to 100% by weight of the nonaqueous electrolyte secondary battery porous layer (B layer).

<Nonaqueous Electrolyte Secondary Battery Separator>

A nonaqueous electrolyte secondary battery separator 2, in which the nonaqueous electrolyte secondary battery porous layer (B layer) was disposed on one surface of the A layer, was obtained as in Example 1 except that the coating solution 2 was used instead of the coating solution 1.

<Evaluation of Physical Properties>

A thickness of the entire nonaqueous electrolyte secondary battery separator 2 obtained and a thickness and a weight per unit area of the B layer obtained were measured by the above-described method. The results are shown in Table 1.

[Preparation of Nonaqueous Electrolyte Secondary Battery]

A nonaqueous electrolyte secondary battery 2 was prepared as in Example 1 except that the nonaqueous electrolyte secondary battery separator 2 was used instead of the nonaqueous electrolyte secondary battery separator 1.

<Evaluation of High-Temperature Constant-Voltage Charge Preservability>

The nonaqueous electrolyte secondary battery 2 obtained was subjected to the above constant-voltage charge preservability test, and the values of electric current were measured. The values of the electric currents were accumulated, and the accumulated electric current values were used as a value of a high-temperature constant-voltage charge preservability. The results are shown in Table 2.

### Example 3

[Preparation of Nonaqueous Electrolyte Secondary Battery Separator]

<A Layer>

A porous film (A layer) made of polyethylene was prepared as in Example 1.

<B Layer>

At room temperature, to a 2-L separable flask in which nitrogen substitution had been performed, 154.15 g of resorcin and 113.63 g of 37% aqueous formaldehyde solution were added so that a molar ratio between the resorcin and formaldehyde would be 1:1. Then, 1541.5 g of water and 0.0786 g of sodium carbonate were further added. While the resulting mixture was being stirred, a temperature of the mixture was raised to 80° C., and the stirring was continued. The mixture was maintained at 80° C. for 24 hours, so that a polymerization reaction was made. This produced a suspension containing fine particles of a resorcin-formalin resin (RF resin). After the suspension was cooled, the suspension thus obtained was centrifuged, so that the fine particles of the RF resin precipitated. Then, a supernatant dispersion medium was removed while the precipitating fine particles of the RF resin were left. Then, the RF resin was cleaned by carrying out, twice, a cleaning operation including: adding water which serves as a cleaning liquid; stirring the resulting mixture; and centrifuging the mixture so as to remove the cleaning liquid. The fine particles of the RF resin thus cleaned was dried, so that an organic filler (1) was quantitatively synthesized. An “inclination in accordance with an embodiment of the present invention” of the organic filler (1) and D50 of the organic filler (1) were measured by the above method. The results are shown in Table 2. Table 2 shows the amount of the organic filler contained in the B layer (unit: % by weight) relative to 100% by weight of the nonaqueous electrolyte secondary battery porous layer (B layer).

A coating solution 3 was prepared as in Example 1 except that the organic filler (1) was used as an organic filler.

<Nonaqueous Electrolyte Secondary Battery Separator>

A nonaqueous electrolyte secondary battery separator 3, in which the nonaqueous electrolyte secondary battery porous layer (B layer) was disposed on one surface of the A layer, was obtained as in Example 1 except that the coating solution 3 was used instead of the coating solution 1.

<Evaluation of Physical Properties>

A thickness of the entire nonaqueous electrolyte secondary battery separator 3 obtained and a thickness and a weight per unit area of the B layer obtained were measured by the above-described method. The results are shown in Table 1.

[Preparation of Nonaqueous Electrolyte Secondary Battery]

A nonaqueous electrolyte secondary battery 3 was prepared as in Example 1 except that the nonaqueous electrolyte secondary battery separator 3 was used instead of the nonaqueous electrolyte secondary battery separator 1.

<Evaluation of High-Temperature Constant-Voltage Charge Preservability>

The nonaqueous electrolyte secondary battery 3 obtained was subjected to the above constant-voltage charge preservability test, and the values of electric current were measured. The values of the electric currents were accumulated, and the accumulated electric current values were used as a value of a high-temperature constant-voltage charge preservability. The results are shown in Table 2.

### Example 4

A laminated porous film 4 was prepared by use of an A layer and a B layer described below.

<A Layer>

A porous film (A layer) made of polyethylene was prepared as in Example 1.

<B Layer>

An organic filler (2) was quantitatively synthesized as in Example 3 except that 154.15 g of resorcin and 227.25 g of 37% aqueous formaldehyde solution were mixed so that a molar ratio between the resorcin and formaldehyde would be 1:2. An “inclination in accordance with an embodiment of the present invention” of the organic filler (2) and D50 of the organic filler (2) were measured by the above method. The results are shown in Table 2. Table 2 shows the amount of the organic filler contained in the B layer (unit: % by weight) relative to 100% by weight of the nonaqueous electrolyte secondary battery porous layer (B layer).

A coating solution 4 was prepared as in Example 1 except that (i) the particles of the organic filler (2) was used as an organic filler and (ii) a mixture ratio was changed so that 100 parts by weight of the organic filler (2) and 3 parts by weight of the CMC were mixed.

<Nonaqueous Electrolyte Secondary Battery Separator>

The laminated porous film 4, in which a nonaqueous electrolyte secondary battery porous layer (B layer) was disposed on one surface of the A layer, was obtained as in Example 1 except that the coating solution 4 was used instead of the coating solution 1. The laminated porous film 4 was used as a nonaqueous electrolyte secondary battery separator 4.

[Preparation of nonaqueous electrolyte secondary battery]

A nonaqueous electrolyte secondary battery 4 was prepared as in Example 1 except that the nonaqueous electrolyte secondary battery separator 4 was used instead of the nonaqueous electrolyte secondary battery separator 1.

<Evaluation of High-Temperature Constant-Voltage Charge Preservability>

The nonaqueous electrolyte secondary battery 4 obtained was subjected to the above constant-voltage charge preservability test, and the values of electric current were measured. The values of the electric currents were accumulated, and the accumulated electric current values were used as a value of a high-temperature constant-voltage charge preservability. The results are shown in Table 2.

### Comparative Example 1

[Preparation of Nonaqueous Electrolyte Secondary Battery Separator]

<A Layer>

A porous film (A layer) made of polyethylene was prepared as in Example 1.

<B Layer>

A coating solution 5 was prepared as in Example 1 except that PMMA (Techpolymer: manufactured by Sekisui Plastics Co., Ltd.) was used as an organic filler. An “inclination in accordance with an embodiment of the present invention” of the organic filler and D50 of the organic filler were measured by the above method. The results are shown in Table 2. Table 2 shows the amount of the organic filler contained in the B layer (unit: % by weight) relative to 100% by weight of the nonaqueous electrolyte secondary battery porous layer (B layer).

<Nonaqueous Electrolyte Secondary Battery Separator>

A nonaqueous electrolyte secondary battery separator 5, in which the nonaqueous electrolyte secondary battery porous layer (B layer) was disposed on one surface of the A layer, was obtained as in Example 1 except that the coating solution 5 was used instead of the coating solution 1.

<Evaluation of Physical Properties>

A thickness of the entire nonaqueous electrolyte secondary battery separator 5 obtained and a thickness and a weight per unit area of the B layer obtained were measured by the above-described method. The results are shown in Table 1.

[Preparation of Nonaqueous Electrolyte Secondary Battery]

A nonaqueous electrolyte secondary battery 5 was prepared as in Example 1 except that the nonaqueous electrolyte secondary battery separator 5 was used instead of the nonaqueous electrolyte secondary battery separator 1.

<Evaluation of High-Temperature Constant-Voltage Charge Preservability>

The nonaqueous electrolyte secondary battery 5 obtained was subjected to the above constant-voltage charge preservability test, and the values of electric current were measured. The values of the electric currents were accumulated, and the accumulated electric current values were used as a value of a high-temperature constant-voltage charge preservability. The results are shown in Table 2.

### Comparative Example 2

[Preparation of Nonaqueous Electrolyte Secondary Battery Separator]

<A Layer>

A porous film (A layer) made of polyethylene was prepared as in Example 1.

<B Layer>

PVDF (LBG: manufactured by Arkema Inc.) was used as a binder resin. A melamine resin (EPOSTAR S6: manufactured by Nippon Shokubai Co., Ltd.) was used as an organic filler. An “inclination in accordance with an embodiment of the present invention” of the organic filler and D50 of the organic filler were measured by the above method. The results are shown in Table 2. Table 2 shows the amount of the organic filler contained in the B layer (unit: % by weight) relative to 100% by weight of the nonaqueous electrolyte secondary battery porous layer (B layer).

The organic filler, the PVDF, and the solvent NMP were mixed at the following ratio. Specifically, 5 parts by weight of the PVDF was added relative to 2 parts by weight of the organic filler, and the organic filler, the PVDF, and the solvent were mixed so that a solid content concentration (a total concentration of the organic filler and the PVDF) would be 4.7% by weight in a resulting mixed solution. This produced a dispersion liquid of the organic filler. Then, a coating solution 6 was prepared by stirring the resulting dispersion liquid.

<Laminated Porous Film>

One surface of the A layer was subjected to a corona treatment at 20 W/(m²/min). Then, the surface of the A layer, which surface was subjected to the corona treatment, was coated with the coating solution 6 with use of an applicator. In so doing, for the purpose of uniformly coating the A layer with the coating solution 6, tension was applied to the A layer while a coated part of the A layer was sandwiched between fingers on parts in front of and behind the coated part. Then, the A layer and the coating film were submerged in IPA for 5 minutes, and the coating film was desolvated with ion exchange water for 10 minutes. Then, the coating film was dried, so that a nonaqueous electrolyte secondary battery porous layer (B layer) was formed. Table 2 shows the amount of the organic filler (unit: % by weight) relative to a total weight of the organic filler and the resin in the B layer. This produced a laminated porous film 6 in which the B layer was disposed on the one surface of the A layer.

<Nonaqueous Electrolyte Secondary Battery Separator>

As described above, a laminated porous film 6, in which the B layer is disposed on one surface of the A layer, was obtained. The laminated porous film 6 was used as a nonaqueous electrolyte secondary battery separator 6.

<Evaluation of Physical Properties>

A thickness of the entire nonaqueous electrolyte secondary battery separator 6 obtained and a thickness and a weight per unit area of the B layer obtained were measured by the above-described method. The results of the measurement are shown in Table 1.

[Preparation of Nonaqueous Electrolyte Secondary Battery]

A nonaqueous electrolyte secondary battery 6 was prepared as in Example 1 except that the nonaqueous electrolyte secondary battery separator 6 was used instead of the nonaqueous electrolyte secondary battery separator 1.

<Evaluation of High-Temperature Constant-Voltage Charge Preservability>

The nonaqueous electrolyte secondary battery 6 obtained was subjected to the above constant-voltage charge preservability test, and the values of electric current were measured. The values of the electric currents were accumulated, and the accumulated electric current values were used as a value of a high-temperature constant-voltage charge preservability. The results are shown in Table 2.

[Results]

TABLE 1

| | Nonaqueous electrolyte | Nonaqueous electrolyte secondary battery | |
|---|---|---|---|
| | secondary battery | porous layer | |
| | separator | (B layer) | |
| | Thickness [μm] | Thickness [μm] | Weight per unit area [g/m²] |
| Example 1 | 26.6 | 14.6 | 4.1 |
| Example 2 | 27.3 | 15.3 | 4.3 |
| Example 3 | 27.2 | 15.2 | 4.0 |
| Example 4 | 25.4 | 13.4 | 3.7 |
| Comparative Example 1 | 28.2 | 16.2 | 4.5 |
| Comparative Example 2 | 24.7 | 12.7 | 5.4 |

TABLE 2

| | | | | Nonaqueous electrolyte |
|---|---|---|---|---|
| | Organic filler | | | secondary battery |
| | | | Inclination | Amount of electric current |
| | | | in embodiment of | during initial charging |
| | Content | D50 | present invention | at high temperature |
| | [% by weight] | [μm] | [% by mass/° C.] | [mA] |
| Example 1 | 94 | 2.0 | −0.096 | 19.9 |
| Example 2 | 94 | 0.4 | −0.044 | 14.0 |
| Example 3 | 94 | 1.0 | −0.008 | 25.0 |
| Example 4 | 97 | 1.0 | −0.037 | 23.5 |
| Comparative Example 1 | 94 | 2.0 | −0.107 | 34.1 |
| Comparative Example 2 | 28 | 0.4 | −0.044 | 29.5 |

As shown in Table 2, it was found by comparing Examples 1 through 4 with Comparative Example 1 that a nonaqueous electrolyte secondary battery, which includes a porous layer including an organic filler having an “inclination in accordance with an embodiment of the present invention” of not less than −0.10% by mass/° C., has an excellent preservability at a high temperature after charging.

It was also found by comparing Example 2 with Comparative Example 2 that even a nonaqueous electrolyte secondary battery, which includes a porous layer including an organic filler having an “inclination in accordance with an embodiment of the present invention” of not less than −0.10% by mass/° C., has a decreased preservability at a high temperature after charging, in a case where an amount of the organic filler contained in the battery is small.

That is, it was found that excellent high-temperature constant-voltage charge preservability can be achieved by a nonaqueous electrolyte secondary battery including a porous layer in accordance with an embodiment of the present invention, in which an organic filler having an “inclination in accordance with an embodiment of the present invention” of not less than −0.10% by mass/° C. is contained in an amount of 87% by weight to 99.5% by weight relative to a total weight of the organic filler and a resin.

### INDUSTRIAL APPLICABILITY

A porous layer in accordance with an embodiment of the present invention can be used for production of a nonaqueous electrolyte secondary battery having excellent high-temperature constant-voltage charge preservability.

1. A nonaqueous electrolyte secondary battery porous layer comprising:
an organic filler; and
a resin,
an inclination of a straight line on a TG chart of the organic filler, which straight line connects a point at 150° C. and a point at a TG inflection point temperature, being not less than −0.10% by mass/° C.,
an amount of the organic filler contained in the nonaqueous electrolyte secondary battery porous layer being 87% by weight to 99.5% by weight, relative to 100% by weight of the nonaqueous electrolyte secondary battery porous layer,
the TG inflection point temperature being a temperature at which the following approximation lines intersect in a case where the organic filler is subjected to a heat treatment in which a temperature is raised from 30° C. to 500° C. at a rate of 10° C./min.: (i) an approximation line derived from values between a point at 150° C. and a point at 180° C. on the TG chart with use of Microsoft (registered trademark) Excel (registered trademark) and (ii) an approximation line derived, with use of Microsoft (registered trademark) Excel (registered trademark), from values on the TG chart, which values are within a range of ±1.5° C. from a point having a mean inclination with a lowest value among mean inclinations that are derived from data at every 5 seconds from the point at 180° C. to a point at 500° C. on the TG chart with use of the SLOPE function of Microsoft (registered trademark) Excel (registered trademark).

2. The nonaqueous electrolyte secondary battery porous layer as set forth in claim 1, wherein a value of D50 in a volume-based particle size distribution of the organic filler is not more than 3 μm.

3. The nonaqueous electrolyte secondary battery porous layer as set forth in claim 1, further comprising:
at least one resin selected from the group consisting of a polyolefin, a (meth)acrylate-based resin, a fluorine-containing resin, a polyamide-based resin, a polyester-based resin, and a water-soluble polymer.

4. The nonaqueous electrolyte secondary battery porous layer as set forth in claim 3, wherein
the polyamide-based resin is an aramid resin.

5. A nonaqueous electrolyte secondary battery separator comprising:
a polyolefin porous film; and
a nonaqueous electrolyte secondary battery porous layer recited in claim 1,
the nonaqueous electrolyte secondary battery porous layer being disposed on one surface or both surfaces of the polyolefin porous film.

6. A nonaqueous electrolyte secondary battery member comprising:
a positive electrode;
a nonaqueous electrolyte secondary battery porous layer recited in claim 1; and
a negative electrode,
the positive electrode, the nonaqueous electrolyte secondary battery porous layer, and the negative electrode being arranged in this order.

7. A nonaqueous electrolyte secondary battery comprising:
a nonaqueous electrolyte secondary battery porous layer recited in claim 1.

8. A nonaqueous electrolyte secondary battery member comprising:
a positive electrode;
a nonaqueous electrolyte secondary battery separator recited in claim 5; and
a negative electrode,
the positive electrode, the nonaqueous electrolyte secondary battery separator, and the negative electrode being arranged in this order.

9. A nonaqueous electrolyte secondary battery comprising:
a nonaqueous electrolyte secondary battery separator recited in claim 5.
